(19) United States
(12) Patent Application Publication
(10) Pub. No.: US 2025/0297462 A1
(43) Pub. Date: Sep. 25, 2025

(54) WORK MACHINE AND METHOD OF CONTROLLING WORK MACHINE

(71) Applicant: KOMATSU LTD., Tokyo (JP)

(72) Inventor: Kazumichi OKAJIMA, Tokyo (JP)

(21) Appl. No.: 18/702,035

(22) PCT Filed: Oct. 28, 2022
(86) PCT No.: PCT/JP2022/040449

§ 371 Date: Oct. 17, 2024

(30) Foreign Application Priority Data
Nov. 30, 2021 (JP) 2021-194623

(51) Int. Cl. E02F 9/26; E02F 9/20; E02F 9/24

(52) U.S. Cl. CPC E02F 9/265; E02F 9/2033; E02F 9/24

(57) ABSTRACT

A work machine includes a work machine main body, at least one object detection sensor, a revolving angle sensor, and a control section. The main body includes a traveling unit and a revolving unit disposed above the traveling unit. The revolving unit is revolvable with respect to the traveling unit. The object detection sensor is disposed on the revolving unit. The revolving angle sensor detects a revolving angle of the revolving unit. The control section detects an object around the main body using the object detection sensor by revolving the revolving unit. The control section specifies a position of the object with respect to the main body based on a distance to the object detected by the object detection sensor and the revolving angle at which the object is detected. The control section sets a virtual wall based on the specified position when the object is detected.

### CROSS-REFERENCE TO RELATED APPLICATIONS

This application is a U.S. National stage application of International Application No. PCT/JP2022/040449, filed on Oct. 28, 2022. This U.S. National stage application claims priority under 35 U.S.C. § 119 (a) to Japanese Patent Application No. 2021-194623, filed in Japan on Nov. 30, 2021, the entire contents of which are hereby incorporated herein by reference.

### BACKGROUND

### Technical Field

The present invention relates to a work machine and a method of controlling a work machine.

### Background Art

Excavators are often used for road construction, pipe burying work, etc. When using excavators on roads in urban areas, even when small excavators are used, workers need to operate the excavators while paying attention to obstacles such as vehicles traveling on the side, fences, and guardrails.

Therefore, for example, International Publication No. 2019/189030 discloses setting a virtual wall to restrict the operation of an excavator machine. In International Publication No. 2019/189030, object detection sensors are disposed at the front, rear, left and right parts of the revolving unit, as well as in diagonal part, and obstacles around the excavator are detected and the virtual wall is set by measuring the distance from the excavator.

### SUMMARY

However, in the configuration shown in International Publication No. 2019/189030, it is necessary to dispose a plurality of sensors around the entire circumference of the revolving unit, which increases the cost.

An object of the present disclosure is to provide a work machine and a method of controlling a work machine, whereby it is made possible to reduce costs.

A work machine according to an aspect of the present disclosure includes a work machine main body, at least one object detection sensor, a revolving angle sensor, and a control section. The work machine main body includes a traveling unit and a revolving unit. The revolving unit is disposed above the traveling unit and is revolvable with respect to the traveling body. The object detection sensor is disposed on the revolving unit. The revolving angle sensor detects a revolving angle of the revolving unit. The control section detects an object around the work machine main body using the object detection sensor by revolving the revolving unit. The control section specifies a position of the object relative to the work machine main body based on a distance to the object detected by the object detection sensor and the revolving angle at which the object is detected and set a virtual wall based on the specified position when the object is detected.

A method of controlling a work machine according to another aspect of the present disclosure includes a detection step, a position specifying step, and a setting step. In the detection step, an object around a work machine main body including a traveling unit and a revolving unit is detected by revolving the revolving unit disposed above the traveling unit. In the position specifying step, a position of the object relative to the work machine main body is specified based on a distance from the work machine main body to the object and a revolving angle at which the object is detected. In setting step, a virtual wall is set based on the specified position.

According to aspects of the present disclosure, it is possible to provide a work machine and a method of controlling a work machine, whereby it is made possible to reduce costs.

### BRIEF DESCRIPTION OF DRAWINGS

FIG. 1 is a side view illustrating a hydraulic excavator according to the embodiment of the present disclosure.

FIG. 2 is a plan view illustrating the hydraulic excavator according to the embodiment of the present disclosure.

FIG. 3 is a block diagram illustrating configurations of the hydraulic excavator and its control system according to the embodiment of the present disclosure.

FIG. 4A is a side schematic diagram for explaining posture detection of the hydraulic excavator according to the embodiment of the present disclosure.

FIG. 4B is a plan view for explaining a revolving angle of the hydraulic excavator according to the embodiment of the present disclosure.

FIG. 5A is a side view illustrating the hydraulic excavator in which a work implement is set to an object detection posture in the embodiment of the present disclosure.

FIG. 5B is a plan view illustrating the hydraulic excavator in which a work implement is set to an object detection posture in the embodiment of the present disclosure.

FIG. 6 is a plan view illustrating the hydraulic excavator and an initial virtual wall according to the embodiment of the present disclosure.

FIG. 7 is a plan view illustrating an example of an object detection area in the hydraulic excavator according to the embodiment of the present disclosure.

FIG. 8 is a plan view for explaining detection of objects around the hydraulic excavator according to the embodiment of the present disclosure.

FIG. 9 is a plan view illustrating the hydraulic excavator and a virtual wall set based on positions of objects detected in FIG. 8.

FIG. 10 is a plan view illustrating a construction site.

FIG. 11 is a plan view illustrating a state in which a virtual wall is set at the construction site shown in FIG. 10.

FIG. 12 is a diagram illustrating a display on the hydraulic excavator according to the embodiment of the present disclosure.

FIG. 13 is a flowchart illustrating an operation of creating a virtual wall in the hydraulic excavator according to the embodiment of the present disclosure.

FIG. 14 is a flowchart illustrating an operation of monitoring an approach of a work implement to a virtual wall in a hydraulic excavator according to an embodiment of the present disclosure.

### DETAILED DESCRIPTION OF EMBODIMENT(S)

A hydraulic excavator as an example of a work machine according to the present disclosure will be described below with reference to the drawings.

### Configuration

### (Outline of Hydraulic Excavator 1)

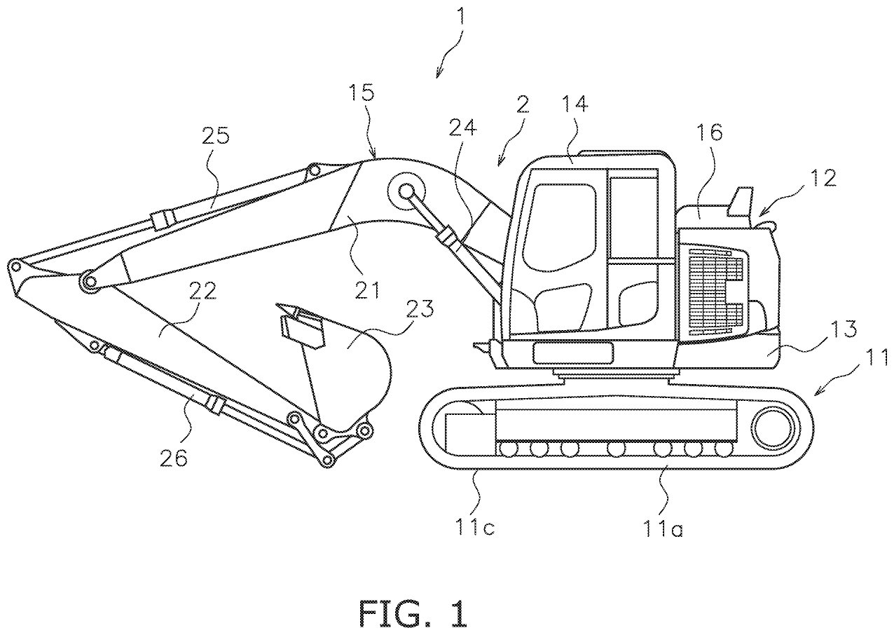

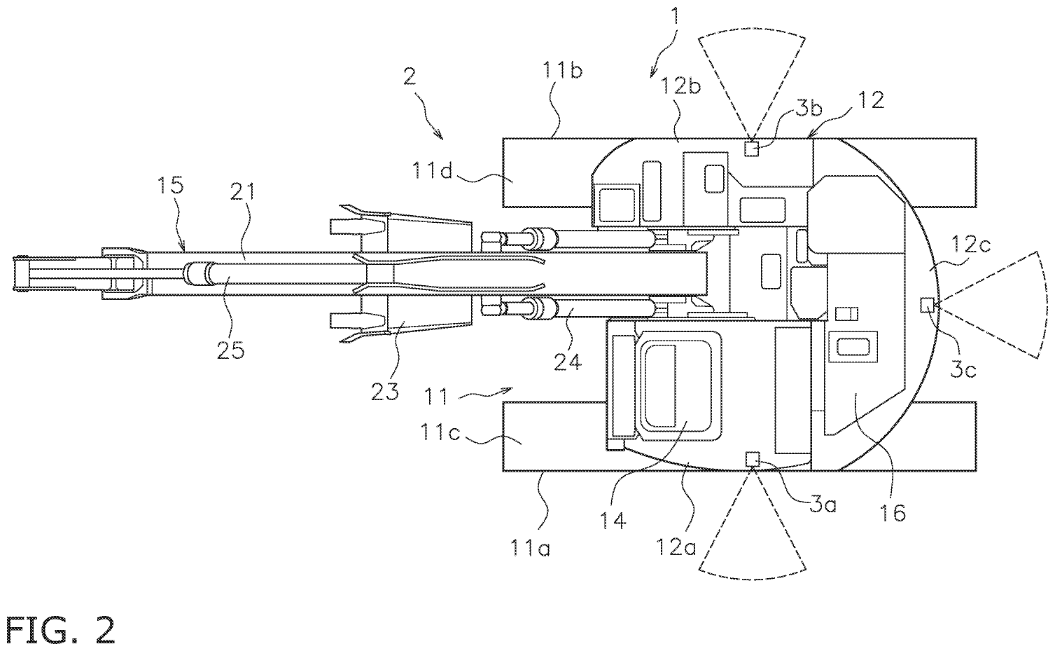

FIG. 1 is a side view illustrating a configuration of a hydraulic excavator 1 according to the present embodiment. FIG. 2 is a plan view illustrating the configuration of the hydraulic excavator 1 according to the present embodiment.

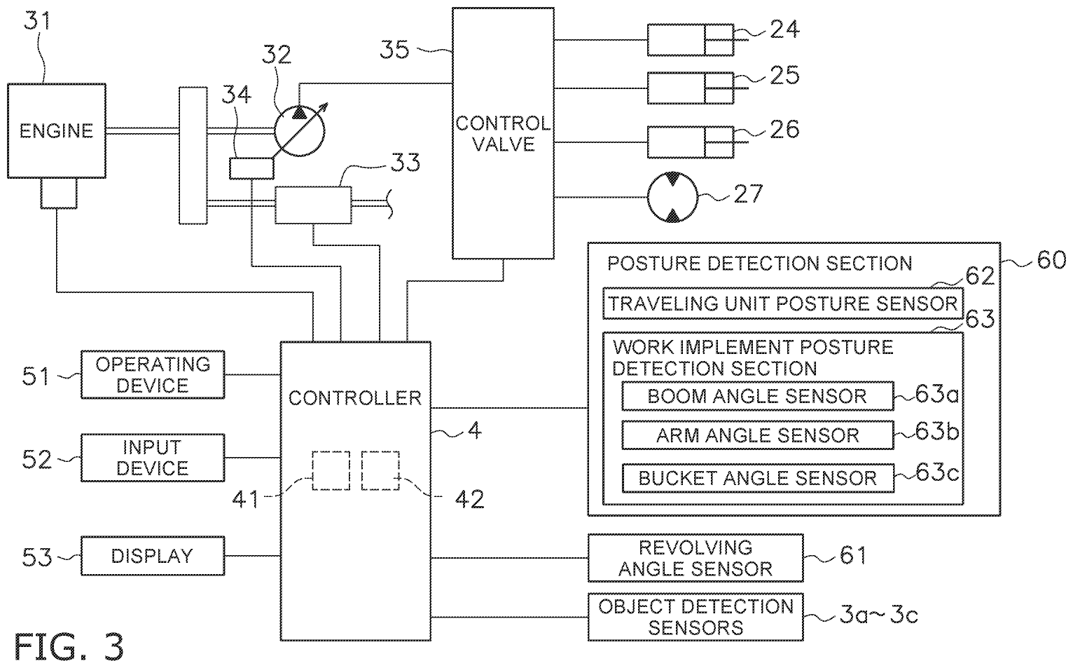

The hydraulic excavator 1 (an example of a work machine) includes a work machine main body 2, object detection sensors 3a to 3c, and a controller 4 (an example of a control section) (see FIG. 3).

The work machine main body 2 includes a traveling unit 11 and a revolving unit 12. The traveling unit 11 includes a pair of traveling devices 11a and 11b. Each of the traveling devices 11a and 11b includes the crawler belts 11c and 11d. The hydraulic excavator 1 travels by rotating a traveling motor with the driving force from an engine and driving the crawler belts 11c and 11d.

The revolving unit 12 is disposed on the traveling unit 11. The revolving unit 12 is configured so as to be revolvable with respect to the traveling unit 11 around an axis extending in a vertical direction by a revolving motor 27 (see FIG. 3). A swing machinery is disposed on the revolving unit 12. A swing circle is disposed on the traveling unit 11 and meshes with an output pinion of the swing machinery. The rotational drive of the revolving motor 27 is decelerated by the swing machinery (not shown) and output from an output pinion. As a result, the swing machinery rotates inside or outside the swing circle, and the revolving unit 12 rotates with respect to the traveling unit 11.

The revolving unit 12 includes a revolving frame 13, a cab 14, and a work implement 15. The revolving frame 13 is disposed above the traveling unit 11 and is a frame that is rotatable with respect to the traveling unit 11. The cab 14 is provided at the front left side of the revolving frame 13. The cab 14 is provided as a driver's seat where an operator sits during operation. Inside the cab 14, a driver's seat, levers for operating the work implement 15, various display devices (including a display 53 to be described later), and the like are disposed.

In this embodiment, unless otherwise specified, front, rear, left and right will be described with reference to the driver's seat inside the cab 14. A direction in which the driver's seat faces the front is defined as a front direction, and a direction opposite to the front direction is defined as a rear direction. A right side and a left side in a lateral direction when the driver's seat faces the front are defined as a right direction and a left direction, respectively.

The work implement 15 is attached to a front central position of the revolving unit 12. The work implement 15 includes a boom 21, an arm 22, and a bucket 23, as shown in FIG. 1. A base end part of the boom 21 is rotatably connected to the revolving unit 12. Further, a distal end part of the boom 21 is rotatably connected to a base end part of the arm 22. A distal end part of the arm 22 is rotatably connected to the bucket 23. The bucket 23 is attached to the arm 22 so that its opening can face toward the revolving unit 12 (rear direction). The hydraulic excavator 1 including the bucket 23 attached in this manner is referred to as a backhoe.

Hydraulic cylinders 24 to 26 (boom cylinder 24, arm cylinder 25, and bucket cylinder 26) are disposed to correspond to boom 21, arm 22, and bucket 23, respectively. The work implement 15 is driven by driving these hydraulic cylinders 24 to 26. As a result, work such as excavation is performed.

An engine room 16 is disposed behind the cab 14 of the revolving unit 12. The engine room 16 houses an engine, a cooling unit for cooling the engine, a hydraulic pump, and the like.

### (Object Detection Sensors 3a to 3c)

The object detection sensors 3a to 3c detect objects around the work machine main body 2. The object detection sensors 3a to 3c detect the presence of an object, detect distance information regarding the distance from each of the object detection sensors 3a to 3c to the object, and transmit a detected distance information to the controller 4. As the object detection sensors 3a to 3c, at least one type of millimeter wave radar, ultrasonic sensor, LiDAR (Laser Imaging Detection and Ranging), camera, etc. can be used. Note that the distance information may be the distance itself, or may be information necessary for the controller 4 to calculate the distance.

As shown in FIG. 2, the object detection sensors 3a to 3c are disposed on a left side surface part 12a, a right side surface part 12b, and a rear side surface part 12c of the revolving unit 12 of the work machine main body 2, respectively. The object detection sensor 3a disposed on the left side surface part 12a detects an object present on the left side of the periphery of the revolving unit 12. The object detection sensor 3b disposed on the right side surface part 12b detects an object present on the right side of the periphery of the revolving unit 12. The object detection sensor 3c disposed on the rear side surface part 12c detects an object present on the rear side of the periphery of the revolving unit 12.

The object detection sensors 3a to 3c are disposed at locations other than the front part of the revolving unit 12 where the work implement 15 is arranged so that the detection direction of each of the object detection sensors 3a to 3c does not overlap with the work implement 15. Thereby, erroneous detection of objects by the work implement 15 can be suppressed.

### (Control Configuration of Hydraulic Excavator 1)

FIG. 3 is a block diagram illustrating configurations of the hydraulic excavator and its control system. As shown in FIG. 3, the hydraulic excavator 1 includes an engine 31, a hydraulic pump 32, a power transmission device 33, a pump control device 34, a control valve 35, and the controller 4 described above.

The engine 31 is controlled by a command signal from the controller 4. The hydraulic pump 32 is driven by the engine 31 and discharges hydraulic fluid. The hydraulic fluid discharged from the hydraulic pump 32 is supplied to the boom cylinder 24, the arm cylinder 25, the bucket cylinder 26, and the revolving motor 27.

The above-described revolving motor 27 is, for example, a hydraulic motor. The revolving motor 27 is driven by hydraulic fluid from the hydraulic pump 32. The revolving motor 27 revolves the revolving unit 12.

Hydraulic pump 32 is a variable displacement pump. A pump control device 34 is connected to the hydraulic pump 32. The pump control device 34 controls the tilt angle of the hydraulic pump 32. The pump control device 34 includes, for example, an electromagnetic valve, and is controlled by a command signal from the controller 4. The controller 4 controls the capacity of the hydraulic pump 32 by controlling the pump control device 34. Note that although one hydraulic pump is illustrated in FIG. 3, a plurality of hydraulic pumps may be provided.

The control valve 35 controls the flow rate of hydraulic fluid supplied from the hydraulic pump 32 to the hydraulic cylinders 24 to 26 and the revolving motor 27. The hydraulic cylinders 24 to 26, the revolving motor 27, and the hydraulic pump 32 are connected by a hydraulic circuit via a control valve 35. The control valve 35 is controlled by a command signal from the controller 4. The controller 4 controls the operation of the work implement 15 by controlling the control valve 35. The controller 4 controls the revolution of the revolving unit 12 by controlling the control valve 35.

The power transmission device 33 transmits the driving force of the engine 31 to the traveling unit 11. The crawler belts 11c and 11d are driven by the driving force from the power transmission device 33 to cause the hydraulic excavator 1 to travel. The power transmission device 33 may be, for example, a torque converter or a transmission having multiple speed change gears. Alternatively, the power transmission device 33 may be another type of transmission such as HST (Hydro Static Transmission) or HMT (Hydraulic Mechanical Transmission).

The controller 4 includes a processor 41 such as a CPU. The processor 41 performs processing for controlling the hydraulic excavator 1. Controller 4 includes a storage device 42. The storage device 42 includes a memory such as RAM or ROM, and an auxiliary storage device such as an HDD (Hard Disk Drive) or an SSD (Solid State Drive). The storage device 42 stores data and programs for controlling the hydraulic excavator 1.

The control system of the hydraulic excavator 1 includes an operating device 51. The operating device 51 is operable by an operator. The operating device 51 includes, for example, a lever, a pedal, or a switch. The operating device 51 outputs an operating signal to the controller 4 according to an operation by an operator. The controller 4 controls the control valve 35 to operate the work implement 15 in accordance with the operation of the operating device 51 by the operator. The controller 4 controls the control valve 35 to revolve the revolving unit 12 in accordance with the operation of the operating device 51 by the operator. The controller 4 controls the engine 31 and the power transmission device 36 to cause the hydraulic excavator 1 to travel in accordance with the operation of the operating device 51 by the operator.

The control system of the hydraulic excavator 1 includes an input device 52 and a display 53 (an example of a display section). The input device 52 is operable by an operator. The input device 52 is, for example, a touch screen. However, the input device 52 may include a hardware key. The operator inputs various settings regarding the hydraulic excavator 1 by operating the input device 52. The input device 52 outputs an input signal according to an operation by an operator. When the operator operates the input device 52, setting control of a virtual wall W, which will be described later, is executed.

The display 53 is, for example, an LCD, OELD, or other type of display. The display 53 displays a screen according to the display signal from the controller 4.

The control system of the hydraulic excavator 1 includes a posture detection section 60 and a revolving angle sensor 61. The posture detection section 60 detects the posture of the hydraulic excavator 1.

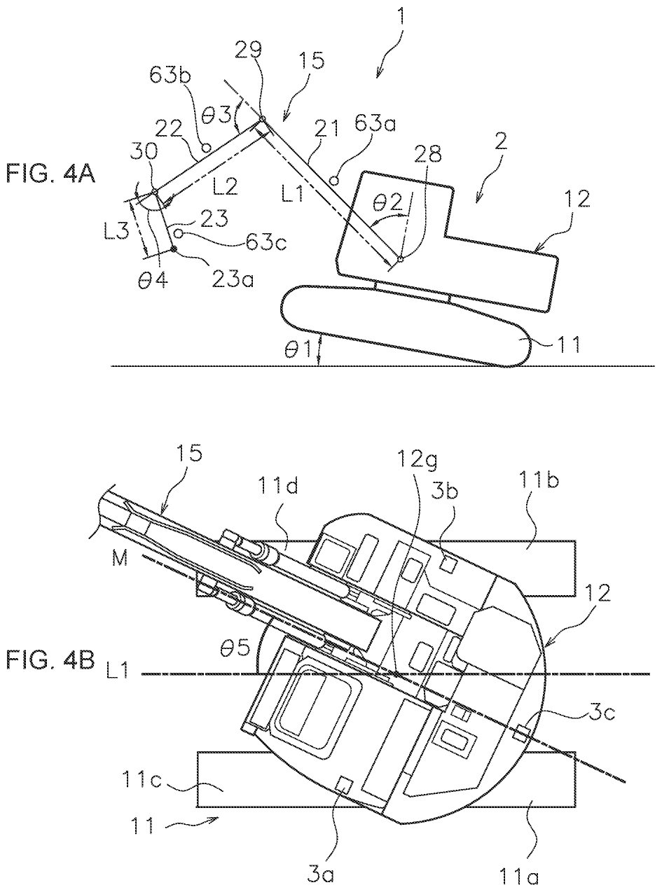

The posture detection section 60 detects the postures of the traveling unit 11 and the work implement 15. The posture detection section 60 includes a traveling unit posture sensor 62 and a work implement posture detection section 63. The traveling unit posture sensor 62 detects the posture of the traveling unit 11. The posture of the traveling unit 11 includes a pitch angle θ1 of the traveling unit 11. The traveling unit posture sensor 62 outputs first posture data including the pitch angle θ1 to the controller 4. As shown in FIG. 4A, the pitch angle θ1 of the traveling unit 11 is an inclination angle of the traveling unit 11 in the front-rear direction with respect to the horizontal direction. The traveling unit posture sensor 62 is, for example, an IMU (Inertial Measurement Unit). The traveling unit posture sensor 62 outputs the first posture data indicating the posture of the traveling unit 11 to the controller 4.

The work implement posture detection section 63 detects the posture of the work implement 15. The posture of the work implement 15 includes a boom angle θ2, an arm angle θ3, and a bucket angle θ4. The work implement posture detection section 63 outputs second posture data indicating the boom angle θ2, the arm angle θ3, and the bucket angle θ4 to the controller 4.

The work implement posture detection section 63 includes a boom angle sensor 63a, an arm angle sensor 63b, and a bucket angle sensor 63c. The boom angle sensor 63a detects boom angle θ2. The boom angle sensor 63a is, for example, an IMU. The boom angle θ2 is an angle of the boom 21 with respect to the vertical direction of the traveling unit 11. The arm angle sensor 63b detects the arm angle θ3. The arm angle θ3 is an angle of the arm 22 with respect to the boom 21. The arm angle sensor 63b is, for example, an IMU. The bucket angle sensor 63c detects the bucket angle θ4. The bucket angle θ4 is an angle of the bucket 23 with respect to the arm 22. The bucket angle sensor 63c detects, for example, a stroke length of the bucket cylinder 26. The bucket angle θ4 is detected from the stroke length of the bucket cylinder 26. The work implement posture detection section 63 outputs the second posture data indicating the posture of the work implement 15 to the controller 4.

The revolving angle sensor 61 detects the revolving angle θ5 of the revolving unit 12 with respect to the traveling unit 11. The revolving angle sensor 61 outputs revolving angle data indicating the revolving angle θ5 to the controller 4. FIG. 4B is a diagram for explaining the revolving angle θ5. As shown in FIG. 4B, a straight line that is a direction along the crawler belts 11c and 11d of the traveling unit 11 and passes through the revolving center 12g of the revolving unit 12 is defined as the first reference line L1. Further, a straight line passing through the revolving center 12g of the revolving unit 12 and along the front-rear direction of the revolving unit 12 is defined as a revolving line M. The revolving angle θ5 is an angle formed by the first reference line L1 and the revolving line M. The revolving angle sensor 61 is, for example, an encoder disposed on the revolving motor 27 or a sensor that detects teeth of a swing machinery.

The controller 4 receives the operation signal from the operating device 51. The controller 4 receives the input signal from input device 52. The controller 4 outputs a display signal to display 53. The controller 4 receives the first posture data from the traveling unit posture sensor 62. The controller 4 receives the second posture data from the work implement posture detection section 63. The controller 4 receives the revolving angle data from the revolving angle sensor 61. The controller 4 receives the distance information to the object from the object detection sensors 3a to 3c.

When the operator operates the input device 52 to execute the setting control of the virtual wall W, the controller 4 sets the work implement 15 to an object detection posture. Then, the controller 4 detects an object around the work machine main body 2 using the object detection sensor 3 while revolving the revolving unit 12 by driving the revolving motor 27. Note that the virtual wall W is a virtual wall set on the controller 4 and is assumed to be disposed perpendicular to the ground.

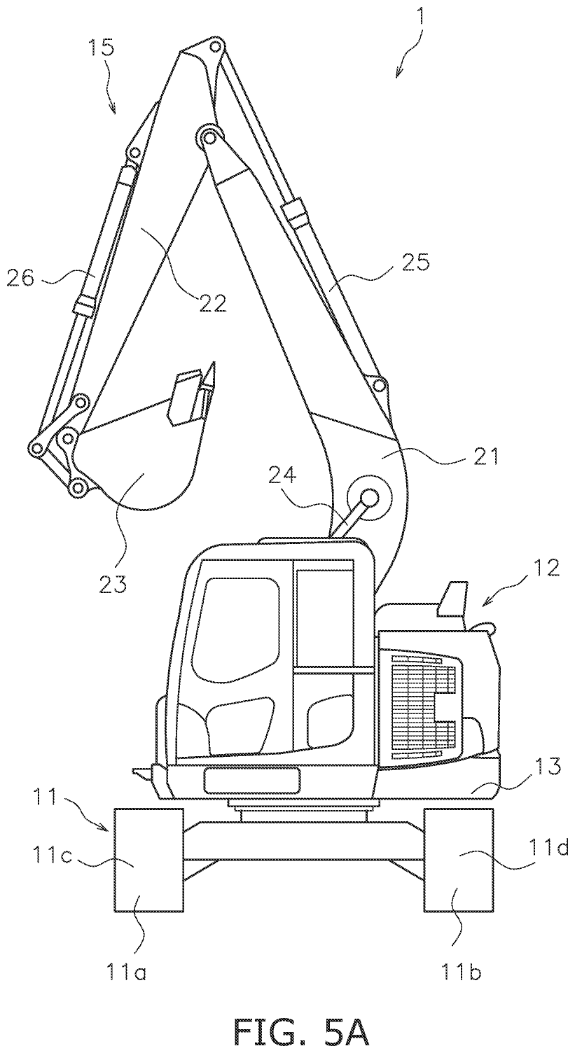

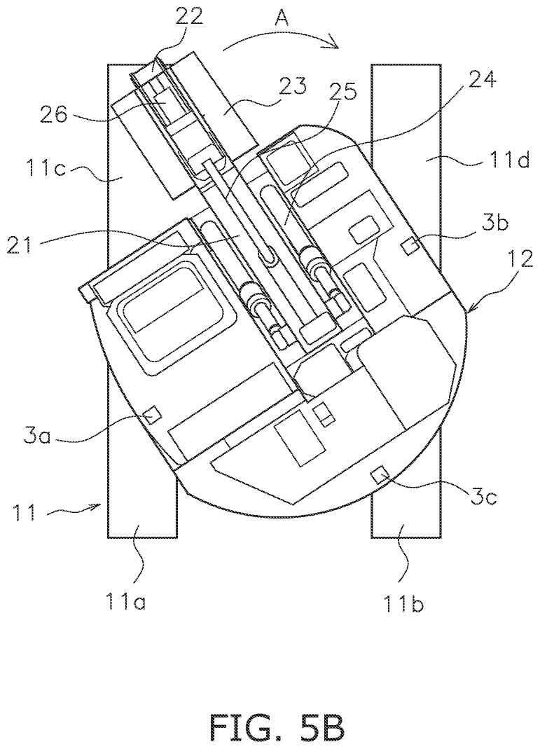

FIG. 5A is a side view illustrating the hydraulic excavator 1 in which the work implement 15 is set to an object detection posture. FIG. 5B is a plan view illustrating the hydraulic excavator 1 in which the work implement 15 is set to the object detection posture. When revolving the revolving unit 12 to detect surrounding objects, it is preferable to keep the work implement 15 in the object detection posture so as to make the revolving radius as small as possible to avoid interference with the object. In the work implement 15 with the object detection posture, the boom angle θ2 is set to the minimum value, the arm angle θ3 is set to the maximum value, and the bucket angle θ4 is set to the maximum value, as shown in FIGS. 5A and 5B. In this state, the revolving unit 12 is revolved in order to detect an object as shown by arrow A in FIG. 5B.

It is preferable that the angle at which the revolving unit 12 is revolved is an angle that allows the object detection sensors 3a to 3c to detect the entire circumference of the work machine main body 2. For example, in this embodiment, since the object detection sensors are disposed on the left side surface part 12a and the right side surface part 12b of the revolving unit 12, by revolving the revolving unit 12 by at least 180 degrees, it is possible to detect all around the work machine main body 2. Further, the same area may be detected by a plurality of object detection sensors, and in that case, the accuracy of object detection can be improved.

### (Virtual Wall Setting)

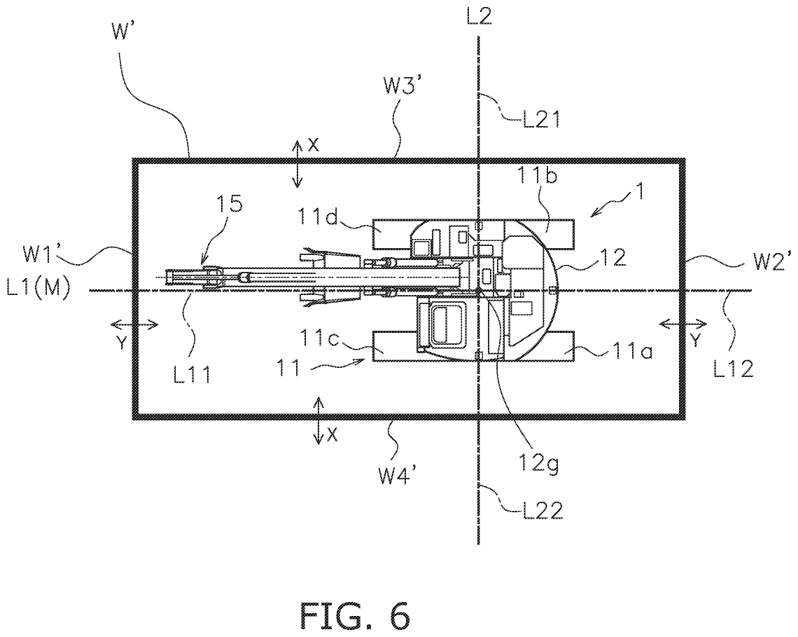

The controller 4 sets the virtual wall W based on the position of the specified object. The controller 4 has an initial virtual wall W′ serving as a template in the storage device 42. FIG. 6 is a plan view illustrating the hydraulic excavator 1 and the initial virtual wall W′. As shown in FIG. 6, the initial virtual wall W′ is set to have a rectangular shape surrounding the entire hydraulic excavator 1. The initial virtual wall W′ is formed by a first initial wall W1′, a second initial wall W2′, a third initial wall W3′, and a fourth initial wall W4′. In FIG. 6, the first reference line L1 and the revolving line M match.

The first initial wall portion W1′ and the second initial wall portion W2′ are disposed perpendicularly to the first reference line L1 of the traveling unit 11. When a second reference line L2 is a straight line that is perpendicular to the first reference line L1 and passes through the revolving center 12g, the third initial wall portion W3′ and the fourth initial wall portion W4′ are disposed perpendicularly to the second reference line L2. One end of the first initial wall portion W1′ and one end of the third initial wall portion W3′ are connected. The other end of the third initial wall portion W3′ and one end of the second initial wall portion W2′ are connected. The other end of the second initial wall portion W2′ and one end of the fourth initial wall portion W4′ are connected. The other end of the fourth initial wall portion W4′ and the other end of the first initial wall portion W1′ are connected. As a result, a rectangular initial virtual wall W′ is formed.

The controller 4 sets the virtual wall W by moving each position of the first initial wall W1′, the second initial wall W2′, the third initial wall W3′, and the fourth initial wall W4′ based on the position of the specified object. As shown in FIG. 6, the first initial wall portion W1′ and the second initial wall portion W2′ are moved in the Y direction (an example of a front rear direction) along the first reference line L1. The third initial wall portion W3′ and the fourth initial wall portion W4′ are moved in the X direction (an example of a width direction) along the second reference line L2.

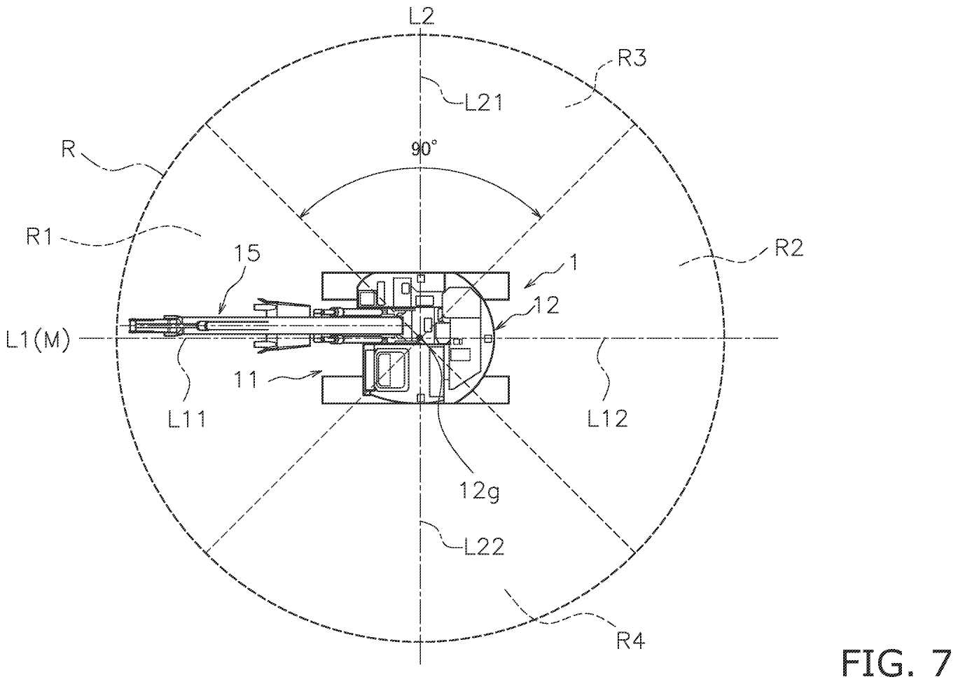

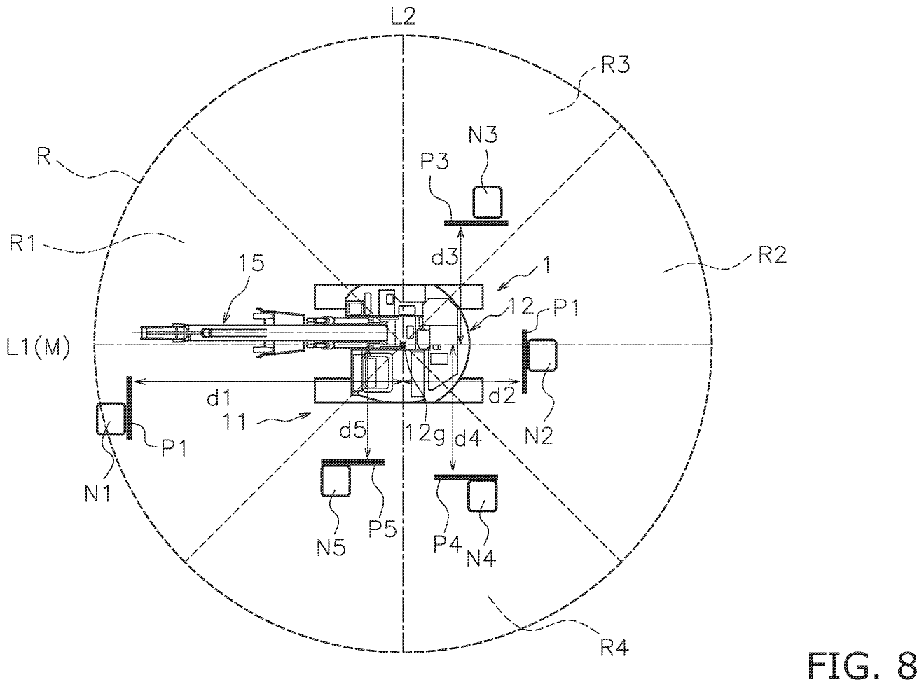

The controller 4 has a detection area that is a circle whose radius is a predetermined distance around the revolving center 12g in a plan view, and divides the detection area into four areas. The predetermined distance may be set as appropriate, but for example, the predetermined distance may be the maximum length that the work implement 15 can reach from the revolving center 12g. FIG. 7 is a plan view illustrating an example of the detection area R. In FIG. 7, the detection area R is divided into four areas at 90° intervals. The detection area R includes a first area R1, a second area R2, a third area R3, and a fourth area R4. Here, among the first reference line L1, a half-line extending in one direction along the first reference line L1 from the revolving center 12g is designated as L11, and a half-line extending in the other direction is designated as L12. The first area R1 is an area extending 45° from the half line L11 to both sides in the circumferential direction. The second area R2 is an area extending 45° from the half-line L12 to both sides in the circumferential direction. The second area R2 is an area formed line-symmetrically with the first area R1 on the second reference line L2.

Among the second reference line L2, a half line extending from the revolving center 12g in one direction along the second reference line L2 is designated as L21, and a half-line extending in the other direction is designated as L21. The third area R3 is an area extending 45° from the half line L21 to both sides in the circumferential direction. The fourth area R4 is an area extending 45° from the half-line L22 to both sides in the circumferential direction. The fourth area R4 is an area formed line-symmetrically with the third area R3 on the first reference line L1.

As shown in FIG. 6, the first initial wall portion W1′ is disposed to perpendicularly intersect the half-line L11, and corresponds to the first area R1. The second initial wall portion W2′ is disposed to perpendicularly intersect the half-line L12, and corresponds to the second area R2. The third initial wall portion W3′ is disposed to perpendicularly intersect the half line L21, and corresponds to the third area R3. The fourth initial wall portion W4′ is disposed to perpendicularly intersect the half-line L22, and corresponds to the fourth area R4.

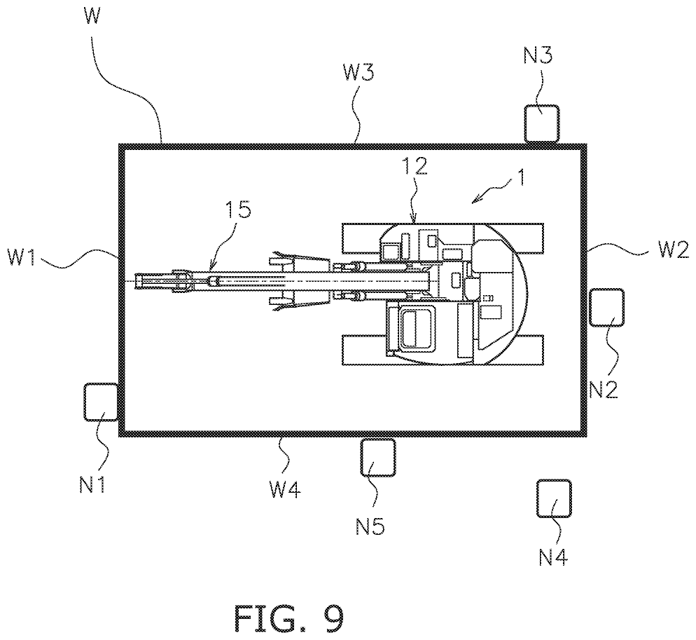

FIG. 8 is a plan view for explaining detection of objects around the hydraulic excavator 1. FIG. 9 is a plan view illustrating the hydraulic excavator 1 and the virtual wall W set based on the positions of the detected objects. In FIG. 8, an object N1 is detected in the first area R1. In the second area R2, an object N2 is detected. In the third area R3, an object N3 is detected. In the fourth area R4, objects N4 and N5 are detected.

The controller 4 specifies the position of the object with respect to the hydraulic excavator 1 based on the distance information to the object received from the object detection sensors 3a to 3c and the revolving angle data when the object is detected. Specifically, the controller 4 specifies the position P1 of the object N1 detected in the first area R1 with respect to the hydraulic excavator 1. The position P1 with respect to the hydraulic excavator 1 is the position of the object N1 from the second reference line L2 along the first reference line L1, and can also be said to be the distance d1 from the second reference line L2 along the first reference line L1 to the object N1. The controller 4 moves the first initial wall portion W1′ of the initial virtual wall W′ along the Y direction to the position P1, and sets the first wall portion W1 of the virtual wall W shown in FIG. 9.

The controller 4 specifies the position P2 of the object N2 detected in the second area R2 with respect to the hydraulic excavator 1. The position P2 with respect to the hydraulic excavator 1 is the position of the object N2 along the first reference line L1 from the second reference line L2, and can also be said to be the distance d2 from the second reference line L2 along the first reference line L1 to the object N2. The controller 4 moves the second initial wall portion W2′ of the initial virtual wall W′ along the Y direction to position P2, and sets the second wall portion W2 of the virtual wall W shown in FIG. 9.

The controller 4 specifies the position P3 of the object N3 detected in the third area R3 with respect to the hydraulic excavator 1. The position P3 with respect to the hydraulic excavator 1 is the position of the object N3 along the first reference line L2 from the second reference line L1 and can also be said to be the distance d3 from the first reference line L1 to the object N3 along the second reference line L2. The controller 4 moves the third initial wall portion W3′ of the initial virtual wall W′ along the X direction to position P3, and sets the third wall portion W3 of the virtual wall W shown in FIG. 9.

The controller 4 specifies the positions P4 and P5 of the objects N4 and N5 detected in the fourth area R4 with respect to the hydraulic excavator 1. Positions P4 and P5 with respect to the hydraulic excavator 1 in the fourth area R4 are the positions of objects N4 and N5 along the second reference line L2 from the first reference line L1, and can also be said to be the distances d4 and d5 from the first reference line L1 to the objects N4 and N5 along the second reference line L2. The controller 4 moves the fourth initial wall portion W4′ of the initial virtual wall W′ along the X direction to the position P5 of the object N5 which is close to the first reference line L1, and sets the fourth wall portion W4 of the virtual wall W shown in FIG. 9.

In this way, when a plurality of objects are detected in the same area, a virtual wall is set at the position of the object that is close to the hydraulic excavator 1.

Note that the positions P1 to P5 may be set to the parts of the objects N1 to N5 that are closest to the hydraulic excavator 1, or the positions P1 to P5 may be positions moved predetermined distances toward the hydraulic excavator 1 side from the parts of the objects N1 to N5 that is closest to the hydraulic excavator 1. A position moved toward the hydraulic excavator 1 side means a position moved from the object toward the hydraulic excavator 1 side along the first reference line L1 in the case of an object detected in the first area R1 and the second area R2. Further, a position moved toward the hydraulic excavator 1 side means a position moved from the object toward the hydraulic excavator 1 side along the second reference line L2 in the case of objects detected in the third area R3 and the fourth area R4.

The controller 4 connects the first wall portion W1 and the third wall portion W3, connects the third wall portion W3 and the second wall portion W2, connects the second wall portion W2 and the fourth wall portion W4, and connects the fourth wall portion W4 and the first wall portion W1. In this way, the controller 4 can set four virtual wall W having four sides which are the front, rear, left and right sides, as shown in FIG. 9, by connecting adjacent wall portions.

Note that when there is an area in the detection area R where no object is detected, it is not necessary to set the wall portion of the virtual wall for the area. For example, when no object is detected in the first area R1, the first wall W1 may not be set.

Furthermore, control such as not setting a predetermined wall portion can be performed through input by the operator using the input device 52.

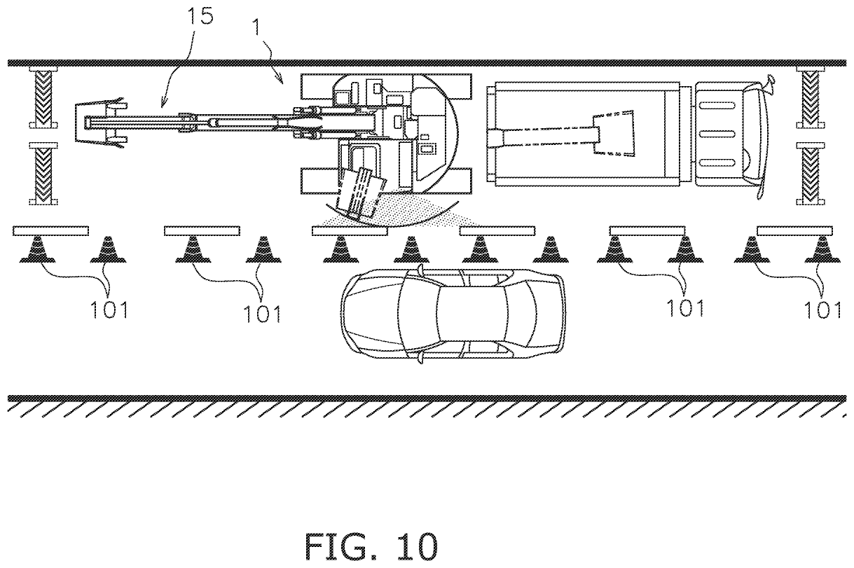

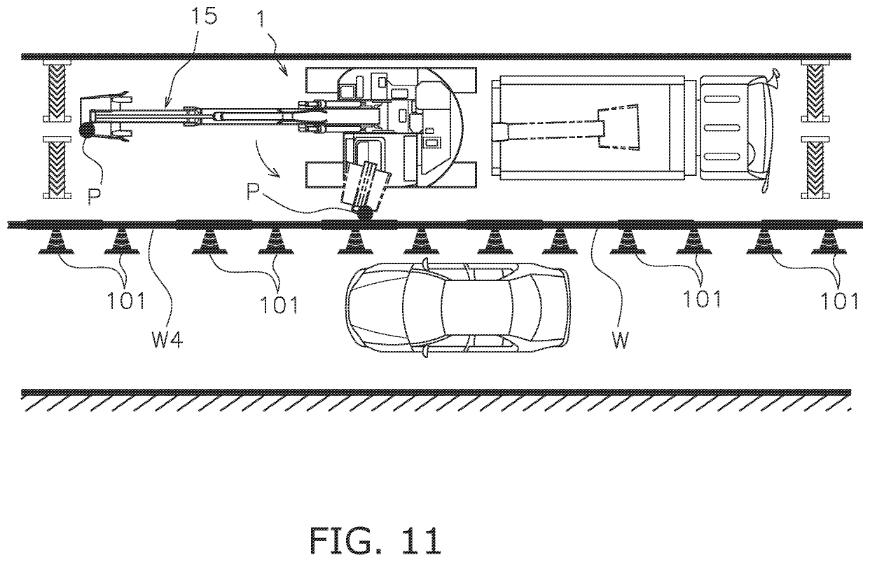

FIG. 10 is a plan view showing a construction site. FIG. 10 shows the construction site where a road is divided by a plurality of road cones 101. FIG. 10 shows a state in which one lane in two lane road is closed for construction work. A plurality of road cones 101 are arranged along the center lane. Vehicles are passing on one side of the road cone 101, and construction is being carried out on the other side. In such a case, the operator can select using the input device 52 (an example of a selection section) not to set the first wall portion W1, the second wall portion W2, and the third wall portion W3. The selection by the operator may be made before performing the object detection by revolving the revolving unit 12, or may be made after performing the object detection. FIG. 11 is a diagram showing a virtual wall W in which only the fourth wall portion W4 is set at the construction site. The virtual wall W shown in FIG. 11 is set along a plurality of road cones 101.

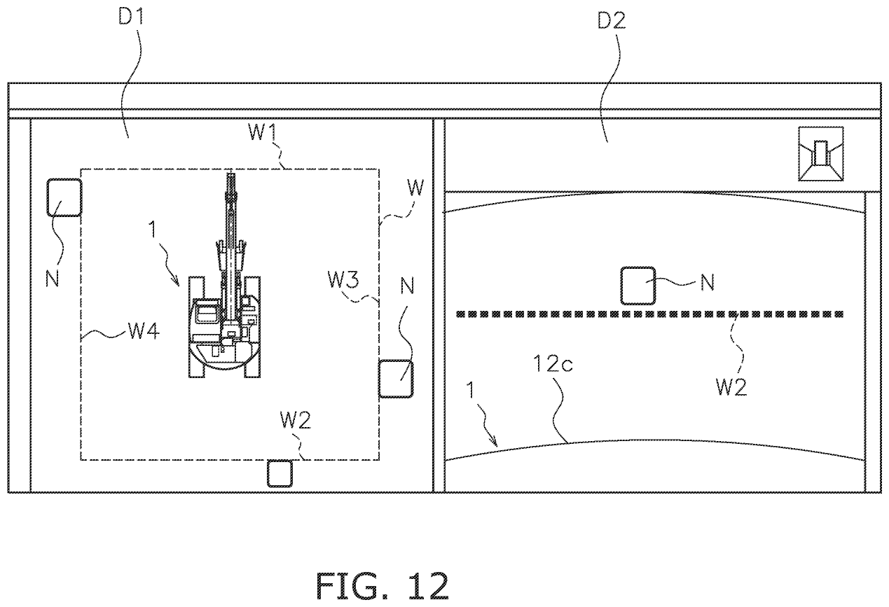

The controller 4 displays the set virtual wall W on the display 53. When the hydraulic excavator 1 includes a camera, the surrounding state is imaged by photographing the entire circumference of the revolving unit 12 when revolving, and the image is displayed on the display 53 together with the virtual wall W. Thereby, the operator can recognize the position where the virtual wall W is provided with respect to the hydraulic excavator 1. On the display screen D1 of the display 53 shown in FIG. 12, the entire hydraulic excavator 1, surrounding objects, and the virtual wall W are displayed in a plan view. On the display screen D2 of the display 53 shown in FIG. 12, the rear side surface part 12c of the hydraulic excavator 1, the second wall portion W2 of the virtual wall W, and the object N are displayed.

### (Monitoring Control)

The controller 4 monitors the approach of the work implement 15 to the virtual wall W.

The controller 4 constantly calculates the outermost position of the work implement 15 based on the first posture data and the second posture data. The outermost position is a position of the work implement 15 that is farthest from the revolving center 12g. In FIG. 11, the outermost position P1 of the work implement 15 is shown.

The storage device 42 stores dimensional data of the work implement 15. The dimensional data is shape data such as the length, thickness, and width of the boom 21, arm 22, and bucket 23.

For example, the dimensional data includes a length L1 of the boom 21, a length L2 of the arm 22, and a length L3 of the bucket 23. In detail, the length L1 of the boom 21 is the distance between a boom pin 28 that connects the boom 21 to the revolving unit 12 and an arm pin 29 that connects the arm 22 to the boom 21. The length L2 of the arm 22 is the distance between the arm pin 29 and a bucket pin 30 that connects the bucket 23 to the arm 22. The length of the bucket 23 is the distance between the bucket pin 30 and a cutting edge 23a of the bucket 23.

The controller 4 calculates the outermost position of the work implement 15 based on the dimensional data stored in the storage device 42 and the pitch angle θ1, the boom angle θ2, the arm angle θ3, and bucket angle θ4.

When the controller 4 detects that the outermost position P1 of the work implement 15 has entered a predetermined range from the virtual wall W, the controller 4 executes an operation restriction on the work implement 15 or the revolving unit 12 to restrict the operation of approaching the virtual wall W. The operation restriction only needs to restrict the operation of the work implement 15 or the revolving unit 12 from approaching the virtual wall W, and includes stopping the operation of the work implement 15 or the revolution of the revolving unit 12. FIG. 11 shows a state in which the outermost position P1 of the work implement 15 enters a predetermined range from the virtual wall W. The controller 4 constantly calculates the outermost position P1, and when the outermost position P1 enters within a predetermined distance from the virtual wall W, the controller 4 decelerates the operation of the work implement 15 or the revolving of the revolving unit 12 and stops the work implement 15 or the revolving unit 12 before reaching the virtual wall W. The predetermined range can be set on the hydraulic excavator 1 side of the virtual wall W, and to a range in which the operation of the work implement 15 and the revolution of the revolving unit 12 can be stopped before reaching the virtual wall W.

By controlling the control valve 35, the controller 4 can stop the supply of hydraulic fluid to the hydraulic cylinders 24 to 26 and the revolving motor 27, and stop the operation of the work implement 15 and the revolution of the revolving unit 12. The controller 4 can stop the operation of the work implement 15 and the revolution of the revolving unit 12 by controlling the pump control device 34 to stop the supply of hydraulic oil from the hydraulic pump 32. Further, by gradually reducing the supply of hydraulic fluid, the operation of the work implement 15 and the revolution of the revolving unit 12 can be decelerated.

When it is detected that the outermost position P1 of the work implement 15 has entered the predetermined range from the virtual wall W and the work implement 15 is operating while the revolving unit 12 has stopped revolving, the controller 4 executes operation restrictions on the work implement 15. Further, when it is detected that the outermost position P1 of the work implement 15 has entered a predetermined range from the virtual wall W and the revolving unit 12 is revolving while the operation of the work implement 15 has stopped, the controller 4 executes operation restriction on the revolution of the revolving unit 12.

Note that the controller 4 may detect that not only the outermost position P1 of the work implement 15 but also other portions of the revolving unit 12 have entered a predetermined range from the virtual wall W.

When the outermost position P1 of the work implement 15 enters within a predetermined distance from the virtual wall W, the controller 4 may decelerate and stop the operation of the work implement 15 or the revolution of the revolving unit 12, and may also issue an alarm. The alarm may be displayed on the display 53, or may be a sound, light, or the like.

### Operation

Next, the control operation of the hydraulic excavator 1 of this embodiment will be explained.

### (Virtual Wall Creation Operation)

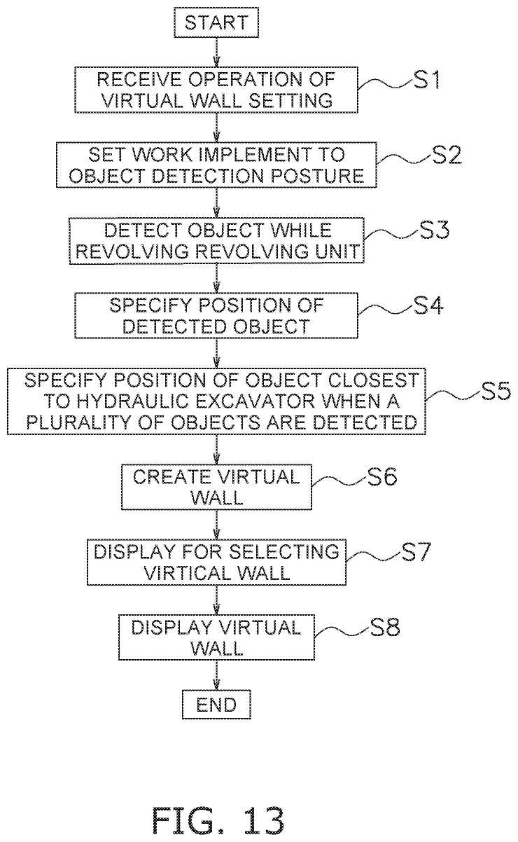

Among the control operations of the hydraulic excavator 1 according to the present embodiment, the operation of creating the virtual wall W will be described. FIG. 13 is a flowchart showing the operation of creating the virtual wall W of the hydraulic excavator 1.

First, in step S1, the controller 4 receives that the operator has performed an input operation using the input device 52 to execute virtual wall setting control.

Next, in step S2, the controller 4 adjusts the hydraulic fluid supplied to the hydraulic cylinders 24 to 26 by controlling the pump control device 34 and the control valve 35, and sets the work implement 15 to the object detection posture shown in FIGS. 5A and 5B.

Next, in step S3, the controller 4 detects an object around the hydraulic excavator 1 using the object detection sensors 3a to 3c while revolving the revolving unit 12. The controller 4 detects an object within the set detection area R. When the controller 4 detects an object outside the detection area R, it does not need to determine that the object has been detected.

Next, in step S4, the controller 4 specifies the position of the detected object based on the distance information from the sensor that detected the object among the object detection sensors 3a to 3c to the object and the revolving angle θ5 when the object was detected. In the example shown in FIG. 8, an object N1 is detected in the first area R1 and a position P1 is specified. An object N2 is detected in the second area R2 and a position P2 is specified. An object N3 is detected in the third area R3, and a position P3 is specified. Objects N4 and N5 are detected in the fourth area R4, and positions P4 and P5 are specified.

Next, in step S5, when a plurality of objects are detected in each of the plurality of areas obtained by dividing the detection area R, the controller 4 specifies the position of the object closest to the hydraulic excavator 1 in each area. In the fourth area R4, since two objects N4 and N5 are detected, the position P5 of the object N5 that is closer to the hydraulic excavator 1 is adopted.

Next, in step S6, the controller 4 moves the wall portion of the initial virtual wall corresponding to each area to the position of the object specified in each area, and sets the virtual wall W. In the specific example, the controller 4 moves the first initial wall portion W1′ of the initial virtual wall W′ to the position P1, moves the second initial wall portion W2′ of the initial virtual wall W′ to the position P2, moves the third initial wall portion W3′ of the wall W′ to position P3, and moves the fourth initial wall portion W4′ of the initial virtual wall W′ to position P5. Then, the controller 4 creates the virtual wall W by connecting the first wall portion W1 and the third wall portion W3, connecting the third wall portion W3 and the second wall portion W2, connecting the second wall portion W2 and the fourth wall portion W4, and connecting the fourth wall portion W4 and the first wall portion W1.

Next, in step S7, the controller 4 causes the display 53 to display a display for selecting whether or not to set each wall portion of the created virtual wall W. Looking at this display, the operator uses the input device 52 to select whether to set each wall portion of the virtual wall W. For example, as shown in FIG. 11, the operator can select to set only the fourth wall portion W4.

Next, in step S8, the controller 4 causes the display 53 to display the hydraulic excavator 1 and surrounding images, as well as the virtual wall W formed by the wall portion selected in step S7.

Thereby, a virtual wall W can be set based on the detected object.

### (Approach Monitoring Operation)

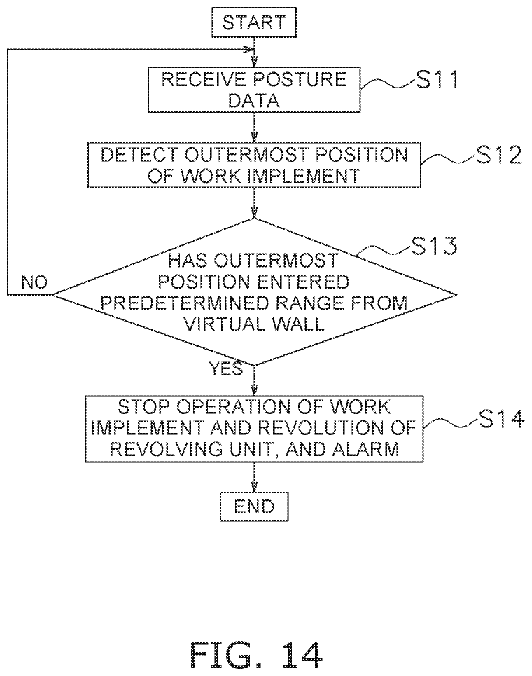

Next, monitoring the approach of the work implement 15 to the virtual wall W among the control operations of the hydraulic excavator 1 according to the present embodiment will be described. FIG. 14 is a flowchart showing the operation of monitoring the approach of the work implement 15 to the virtual wall W.

First, in step S11, the controller 4 receives first posture data and second posture data including pitch angle θ1, boom angle θ2, arm angle θ3, and bucket angle θ4.

Next, in step S12, the controller 4 calculates the outermost position P of the work implement 15 from the dimension data stored in the storage device 42 and the received pitch angle θ1, boom angle θ2, arm angle θ3, and bucket angle θ4.

Next, in step S13, the controller 4 determines whether the calculated outermost position P has entered the range of a predetermined distance from the virtual wall W.

When it is determined in step S13 that the outermost position P has not entered the predetermined range, the control returns to step S11, and the controller 4 receives the first posture data and the second posture data.

When it is determined in step S13 that the outermost position P has entered the predetermined range, the controller 4 stops the operation of the work implement 15 in step S14. Specifically, the controller 4 reduces and stops the supply of hydraulic fluid to the hydraulic cylinders 24 to 26 and the revolving motor 27 by controlling at least one of the pump control device 34 and the control valve 35. As a result, the operation of the work implement 15 and the revolution of the revolving unit 12 are decelerated and stopped. Further, the controller 4 displays an alarm on the display 53.

Thereby, it is possible to prevent the work implement from approaching the detected object during the work.

### (Features)

(1)

The hydraulic excavator 1 of the present embodiment includes the work machine main body 2, object detection sensors 3a to 3c, the revolving angle sensor 61, and the controller 4 (an example of a control section). The work machine main body 2 includes the traveling unit 11 and the revolving unit 12. The revolving unit 12 is disposed above the traveling unit 11 and can revolve with respect to the traveling unit 11. The object detection sensors 3a to 3c are disposed on the revolving unit 12. The revolving angle sensor 61 detects the revolving angle of the revolving unit 12. The controller 4 revolves the revolving unit 12 and detects objects around the work machine main body 2 using the object detection sensors 3a to 3c. When an object is detected, the controller 4 specifies the position of the object with respect to the work machine main body 2 based on the distance to the object detected by the object detection sensors 3a to 3c and the revolving angle at which the object was detected, and set the virtual wall W based on the specified position.

Since an object around the work machine main body 2 is detected by revolving the revolving unit 12 in this manner, the number of object detection sensors to be disposed can be reduced, and costs can be reduced. In addition, since an object around the work machine main body 2 is detected by revolving the revolving unit 12, there is no need to dispose an object detection sensor on a position where there is a risk of false detection by the work implement 15 and it is possible to suppress erroneous detection by the work implement 15.

(2)

In the hydraulic excavator 1 of the present embodiment, the revolving unit 12 includes the work implement 15. The object detection sensors 3a to 3c are disposed on the revolving unit 12 so that their detection directions do not overlap with the work implement 15.

Thereby, it is possible to suppress erroneous detection by the work implement 15.

(3)

In the hydraulic excavator 1 of the present embodiment, the revolving unit 12 includes the work implement 15. The controller 4 executes an operation restriction that restricts the operation of the work implement 15 approaching the virtual wall W.

This prevents the work implement 15 from entering the outside of the virtual wall W, and prevents the work implement 15 from coming into contact with an object.

(4)

In the hydraulic excavator 1 of the present embodiment, the operation restriction includes stopping the work implement 15.

Thereby, the work implement 15 can be stopped before it enters the outside of the virtual wall W.

(5)

In the hydraulic excavator 1 of the present embodiment, the operation restriction includes stopping the revolving of the revolving unit 12.

Thereby, the revolution of the revolving unit 12 can be stopped before the work implement 15 enters the outside of the virtual wall W.

(6)

In the hydraulic excavator 1 of the present embodiment, the controller 4 executes an operation restriction that restricts the operation of the revolving unit 12 approaching the virtual wall W.

This prevents the revolving unit 12 from entering the outside of the virtual wall W, and prevents the revolving unit 12 from coming into contact with an object.

(7)

In the hydraulic excavator 1 of the present embodiment, the operation restriction includes stopping the revolution of the revolving unit 12.

Thereby, the revolution can be stopped before the revolving unit 12 enters the outside of the virtual wall W.

(8)

The hydraulic excavator 1 according to the present embodiment further includes a posture detection section 60 that detects the postures of the work implement 15 and the traveling unit 11. The controller 4 detects the outermost position P of the work implement 15 and executes operation restriction when the outermost position P enters a predetermined range from the virtual wall W.

In this way, the outermost portion of the work implement 15 can be prevented from entering the virtual wall W, and the work implement 15 can be prevented from coming into contact with an object.

(9)

In the hydraulic excavator 1 of the present embodiment, the controller 4 divides the area around the work machine main body 2 into four areas R1 to R4 (an example of a plurality of areas). The virtual wall W has the first wall portion W1 to the fourth wall portion W4 (an example of a plurality of wall portions) corresponding to the first area R1 to the fourth area R4. Based on the position of the object specified in each of the first area R1 to the fourth area R4, the first wall portion W1 to the fourth wall portion W4 corresponding to the first area R1 to the fourth area R4 are set.

Thereby, the virtual wall W can be set at an appropriate position in each area.

(10)

In the hydraulic excavator 1 of the present embodiment, the controller 4 does not set a wall portion corresponding to an area where an object is not detected.

Thereby, it is possible to prevent the virtual wall W from being placed in a area where no object is detected. For example, when no object is detected on the front side of the work machine main body 2, a wall portion (for example, the first wall portion W1) may not be set on the front side.

(11)

The hydraulic excavator 1 of the present embodiment further includes an input device 52 (an example of a selection section) for selecting whether to set each of the first wall portion W1 to the fourth wall portion W4.

Thereby, it is possible not to set the virtual wall W at a location where the operator has determined that there is no need to provide the virtual wall W. For example, as shown in FIG. 11, only the fourth wall portion W4 can be set.

(12)

In the hydraulic excavator 1 of the present embodiment, the controller 4 stores an initial virtual wall W′ before setting, which is disposed to surround the work machine main body 2. The initial virtual wall W′ includes the first initial wall portion W1′ to the fourth initial wall portion W4′. The controller 4 sets the first wall portion W1 to the fourth wall portion W4 by moving the first initial wall portion W1′ to the fourth initial wall portion W4′ based on the position of the object.

As a result, the virtual wall W can be set by moving appropriately the first initial wall portion W1′ to the fourth initial wall portion W4′ of the initial virtual wall W′ stored as a template by the controller 4 in accordance with the detection of the object.

(13)

The hydraulic excavator 1 of the present embodiment further includes a display 53 (an example of a display section) that displays at least a portion of the work machine main body 2 and at least a portion of the virtual wall W.

Thereby, the operator can confirm the position of the set virtual wall W by checking the display 53.

(14)

In the hydraulic excavator 1 of the present embodiment, the controller 4 divides the periphery of the work machine main body 2 into four areas, which are the first area R1 (an example of a first area), the second area R2 (an example of a second area), the third area R3 (an example of a third area), and the fourth area R4 (an example of a fourth area), based on the revolving center 12g of the revolving unit 12. The first area R1 is an area on one side in the Y direction (an example of a front-rear direction) along the first reference line L1 of the traveling unit 11, and the second area R2 is an area on the other side in a direction along the first reference line L1 of the traveling unit 11. The third area R3 is an area on one side in the X direction (an example of a width direction) along the second reference line L2 of the traveling unit 11, and the fourth area R4 is an area on the other side in a direction along the second reference line L2 of the traveling unit 11. The virtual wall W has a rectangular shape, and includes the first wall portion W1 disposed along the second reference line L2 on one side in the Y direction of the traveling unit 11, the second wall portion W2 disposed along the second reference line L2 on the other side in the Y direction of the traveling unit 11, the third wall portion W3 disposed along the first reference line L1 on one side in the X direction of the traveling unit 11, and the fourth wall portion W4 disposed along the first reference line L1 on the other side in the X direction of the traveling unit 11. The controller 4 sets the first wall W1 based on the position of the object specified in the first area R1, sets the second wall portion W2 based on the position of the object specified in the second area R2, sets the third wall portion W3 based on the position of the object specified in the third area R3, and sets the fourth wall portion W4 based on the position of the object specified in the fourth area R4.

As a result, it is possible to set a wall portion corresponding to each of the four areas R1 to R4, which are divided based on the revolving center 12g of the revolving unit 12.

(15)

The method for controlling the hydraulic excavator 1 according to the present embodiment includes step S3 (an example of a detection step), step S4 and step S5 (an example of a position specifying step), and step S7 (an example of a setting step). In step S3, the revolving unit 12 disposed above the traveling unit 11 is revolved to detect objects around the work machine main body 2 including the traveling unit 11 and the revolving unit 12. In steps S4 and S5, the position of the object with respect to the work machine main body 2 is specified based on the distance to the object and the revolving angle at which the object was detected. In step S7, the virtual wall W is set based on the specified position.

Since an object around the work machine main body 2 is detected by revolving the revolving unit 12 in this manner, the number of object detection sensors to be disposed can be reduced, and costs can be reduced. In addition, since an object around the work machine main body 2 is detected by revolving the revolving unit 12, there is no need to dispose an object detection sensor on a position where there is a risk of false detection by the work implement 15 and it is possible to suppress erroneous detection by the work implement 15.

### OTHER EMBODIMENTS

Although one embodiment of the present invention has been described above, the present invention is not limited to the above embodiment, and various changes can be made without departing from the gist of the invention.

### (A)

Note that in the above embodiment, the initial virtual wall W′ is stored in the storage device 42, but the initial virtual wall W′ does not need to be stored. The position of the object detected in each of the first area R1 to the fourth area R4 may be specified, and the first wall portion W1 to fourth wall portion W4 may be set based on the specified position. The virtual wall W may be made by creating the first wall portion W1 and the second wall portion W2 perpendicular to the first reference line L1 in the first area R1 and the second area R2, and creating the third wall portion W3 and the fourth wall portion W4 perpendicular to the second reference line L2 in the third area R3 and the fourth area R4, and connecting the first wall W1 to the fourth wall portion W4.

### (B)

In the embodiment described above, the detection area R is divided into four areas, but the number does not have to be limited to four. Further, the detection area R does not have to be divided into equal intervals. Further, the number of initial wall portions and wall portions does not have to be limited to four, but it is preferable that they correspond to the number of divisions of the detection area R.

### (C)

In the above embodiment, three object detection sensors are disposed, but the number does not have to be limited to three, and the number may be four or more, or two or less. In order to suppress erroneous detection of an object due to the operation of the work implement 15, it is preferable that the object detection sensor is disposed at a position such that its detection direction does not overlap with the work implement 15.

### (D)

In the above embodiment, the boom angle sensor 63a is an IMU, but it is not limited to this, and may be a sensor that detects the stroke length of the boom cylinder 24. Although the arm angle sensor 63b is an IMU, it is not limited to this, and may be a sensor that detects the stroke length of the arm cylinder 25. Further, the bucket angle sensor 63c is a sensor that detects the stroke of the bucket cylinder 26, but it is not limited to this and may be an IMU. In short, the boom angle sensor 63a, the arm angle sensor 63b, and the bucket angle sensor 63c need only be sensors that can detect their respective angles.

### (E)

In the above embodiment, the revolving motor 27 is a hydraulic motor, but is not limited to this, and may be an electric motor. In this case, when the outermost position P of the work implement 15 approaches the virtual wall W, the hydraulic fluid supplied to the hydraulic cylinders 24 to 26 is stopped, and the electric motor is stopped according to a command from the controller 4.

According to the present disclosure, it is possible to suppress false detection and is useful for work machines and the like.

1. A work machine comprising:
a work machine main body including a traveling unit and a revolving unit disposed above the traveling unit, the revolving unit configured to be revolvable with respect to the traveling unit;
at least one object detection sensor disposed on the revolving unit;
a revolving angle sensor configured to detect a revolving angle of the revolving unit; and
a control section configured to
detect an object around the work machine main body using the object detection sensor by revolving the revolving unit,
specify a position of the object with respect to the work machine main body based on a distance to the object detected by the object detection sensor and the revolving angle at which the object is detected and
set a virtual wall based on the specified position when the object is detected.

2. The work machine according to claim 1, wherein
the revolving unit incudes a work implement, and
the object detection sensor is disposed on the revolving unit so that a detection direction does not overlap with the work implement.

3. The work machine according to claim 1, wherein
the revolving unit incudes a work implement, and
the control section is configured to execute an operation restriction that restricts an operation of the work implement approaching the virtual wall.

4. The work machine according to claim 3, wherein
the operation restriction includes stopping the work implement.

5. The work machine according to claim 3, wherein
the operation restriction includes stopping a revolution of the revolving unit.

6. The work machine according to claim 1, wherein
the control section is configured to execute an operation restriction that restricts an operation of the revolving unit approaching the virtual wall.

7. The work machine according to claim 6, wherein
the operation restriction includes stopping a revolution of the revolving unit.

8. The work machine according to claim 3, further comprising:
a posture detection section configured to detect postures of the work implement and the traveling unit,
the control section being configured to detect an outermost position of the work implement, and
execute the operation restriction when the outermost position enters a predetermined range from the virtual wall.

9. The work machine according to claim 1, wherein
the control section is configured to divide a periphery of the work machine main body into a plurality of areas,
the virtual wall includes a plurality of wall portions corresponding to the plurality of areas, and
the wall portions corresponding to the areas are set based on the position of the object specified in each of the areas.

10. The work machine according to claim 9, wherein
the control section does not set the wall portion corresponding to the area where no object is detected.

11. The work machine according to claim 9, further comprising:
a selection section configured to select whether to set each of the plurality of wall portions.

12. The work machine according to claim 9, wherein
the control section stores an initial virtual wall before setting that is disposed to surround the work machine main body,
the initial virtual wall includes a plurality of initial wall portions, and the control section is configured to set the wall portion by moving the initial wall portion based on the position of the object.

13. The work machine according to claim 1, further comprising:
a display section configured to display at least a portion of the work machine main body and at least a portion of the virtual wall.

14. The work machine according to claim 1, wherein
the control section is configured to divide a periphery of the work machine main body into four areas, which are a first area, a second area, a third area, and a fourth area, based on a revolving center of the revolving unit,
the first area is an area on one side in a front-rear direction of the traveling unit, and the second area is an area on other side in the front-rear direction,
the third area is an area on one side in a width direction of the traveling unit, and the fourth area is an area on other side in the width direction,
the virtual wall includes a rectangular shape, and includes a first wall portion disposed along the width direction on the one side of the traveling unit, a second wall portion disposed along the width direction on the other side of the traveling unit, a third wall portion disposed along the front-rear direction on the one side in the width direction of the traveling unit, and a fourth wall portion disposed along the front-rear direction on the other side of the traveling unit, and
the control section is configured to set the first wall portion based on the position of the object specified in the first area, to set the second wall portion based on the position of the object specified in the second area, to set the third wall portion based on the position of the object specified in the third area, and to set the fourth wall portion based on the position of the object specified in the fourth area.

15. A method of controlling a work machine, the method comprising:
detecting an object around a work machine main body including a traveling unit and a revolving unit by revolving the revolving unit disposed above the traveling unit;
specifying a position of the object with respect to the work machine main body based on a distance from the work machine main body to the object and a revolving angle at which the object is detected; and
setting a virtual wall based on the specified position.
